(19) United States
(12) Patent Application Publication
(10) Pub. No.: US 2013/0122416 A1
(43) Pub. Date: May 16, 2013

(54) RELEASE FLUID FOR REDUCING GEL BUILD

(71) Applicant: Jerry Alan Pickering, Hilton, NY (US)

(72) Inventor: Jerry Alan Pickering, Hilton, NY (US)

(21) Appl. No.: 13/297,602

(22) Filed: Nov. 16, 2011

(51) Int. Cl. G03G 13/20; C09D 7/12

(52) U.S. Cl. 430/124.1; 106/287.11

(57) ABSTRACT

A releasing fluid is disclosed. The releasing fluid includes: an end functional polydimethylsiloxane formed of Formula (i):

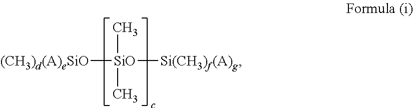

a pendent functional polydimethlysiloxane formed of Formula (ii):

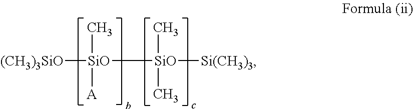

a combination of end and pendent functional siloxane formed of Formula (iii):

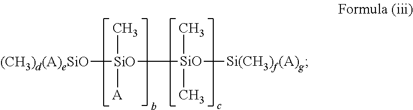

and
wherein the release fluid comprises less than 0.5% by weight of the sum of Formula (i) where e+g>1 and Formula (iii) where e+g are >1.

### FIELD OF THE INVENTION

The present invention relates to a release fluid for fixing toner images providing good releasing property and long fixing member life.

### BACKGROUND OF THE INVENTION

In typical commercial electrostatographic reproduction apparatus (copier/duplicators, printers, or the like), a latent image charge pattern is formed on a uniformly charged charge-retentive or photo-conductive member having dielectric characteristics (hereinafter referred to as the dielectric support member). Pigmented marking particles (toner) are attracted to the latent image charge pattern to develop such image on the dielectric support member. The developed image is transferred to a receiver member, such as a sheet of paper, transparency or other medium, in an electric field. After transfer, the receiver member bearing the transferred image is transported away from the dielectric support member, and the image is fixed (fused) to the receiver member by heat and pressure to form a permanent reproduction thereon.

Some reproduction apparatus have been designed to use polymeric release fluids during the fixing process to prevent the toner particles from contaminating fixing members. Polymeric release fluids are typically polydimethylsiloxane fluids having room temperature viscosity in the range of 200 cSt to 100,000 cSt and are applied at rates of a few 10ths of a ul per A4 sheet to 10 ul or more per sheet. The method for application of the release fluid is dependent in part on the quantity, uniformity and viscosity of the release fluid. For apparatus requiring a high quality uniform application of several microliters per A4 sheet of fluid, a donor roller oiler is typically employed. Donor roll oiler requires a relatively low viscosity fluid, typically less than a thousand cSt. Polydimethyl siloxane fluids viscosity is largely determined by the molecular weight of the fluid.

Additionally, when the fixing members have an outermost layer comprising a fluoroelastomer or include metallic or ceramic surfaces such as heating rollers, the preferred release fluids contain functional groups to enhance the interaction of the release fluid with the fixing member surfaces. Preferred functional groups include amine, carboxy, and mercapto functionality. Functional silicone release fluids also interact with toner surfaces to prevent contamination of fixing member surfaces, particularly in the case of polyester toners. The strong interaction of the functional group with a surface binds the polymeric release fluid to the surface forming a protective layer to prevent contamination by the toner marking particles.

It is known that performance of functional release fluids is, at least in part, dependent on the concentration of the functional groups and the frequency of groups on the polymeric chains. If the concentration of functionality is too dilute, the functional groups are too few to form an effective barrier in the presence of chemical and mechanical wear. Conversely, if the concentration of functional groups is too great, then the polymeric chains of the release fluid can contain excessive functionality and bind to multiple surfaces. In this manner the release agent behaves as a glue rather than a release agent. A successful release fluid forms an effective barrier layer without acting as a glue.

It is also known that in the case of end-terminated release agents, that is linear polymeric release agents where the functionality is located at the end of the chain, low molecular weight (or oligomeric) di-functional compounds can act to form a gel layer. This gel layer eventually causes the fixing member surface properties to change and causes premature removal of the fixing member. U.S. Patent Application Publication 20090105100 describes a method for reducing the concentration of di-functional oligomeric compounds to reduce the rate of gel formation and improve the life of the fixing member. The method dilutes the concentration of functional groups with non-functional groups to reduce presence of oligomeric difunctional compounds. The extent of the reduction is determined by the molecular weight of the release fluid and the concentration of the functionality.

### SUMMARY OF THE INVENTION

It would be desirable to have a method for reducing the presence of low molecular weight di-functional compounds without changing the concentration of the functional groups or the viscosity of the fluid.

In accordance with the present invention there is provided a method for fixing toner images formed on substrates while forming a copolymer gel, comprising:

providing a fuser member having a top surface including a fluoroelastomer surface;

during fusing of images continuously applying a releasing fluid onto the surface of the fusing member wherein the releasing fluid includes an end functional polydimethylsiloxane formed of Formula (i):

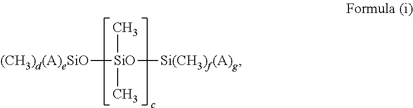

a pendent functional polydimethlysiloxane formed of Formula (ii):

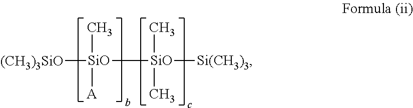

a combination of end and pendent functional siloxane formed of Formula (iii):

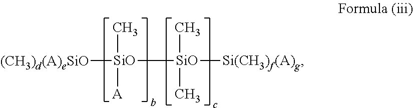

and wherein the release fluid comprises less than 0.5% by weight of the sum of Formula (i) where e+g>1 and Formula (iii) where e+g are >1;

and heating the surface with the release fluid mixture to form a crosslinked copolymeric gel comprising the release mixture components.

In another aspect of the invention there is provided a releasing fluid comprising: an end functional polydimethylsiloxane, a pendent functional polydimethlysiloxane, and a combination of end and pendent functional siloxane wherein the functional polydimethyl siloxanes, respectively, include the end functional polydimethylsiloxane formed of Formula (i)

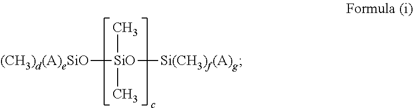

the pendent functional polydimethlysiloxane formed of Formula (ii):

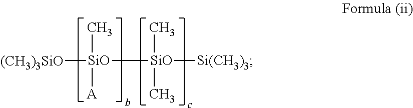

and the combination of end and pendent functional siloxane formed of Formula (iii):

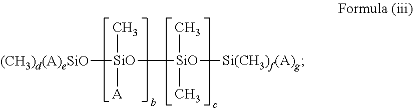

and the release fluid comprises less than 0.5% by weight of the sum of Formula (i) where e+g>1 and Formula (iii) where e+g are >1.

A feature of the present invention is that it permits adjustment of the rate of gel buildup without requiring changes to the viscosity of the release fluid or changes to the concentration of the functional group concentration.

### BRIEF DESCRIPTION OF THE DRAWING

FIG. 1 is a comparative example showing the results of applying test fluid contrast with not applying a test fluid.

### DETAILED DESCRIPTION OF THE INVENTION

It has been found that the concentration of low molecular weight di-functional compounds in an end-terminated release fluid can be significantly reduce by replacement of a portion of the end terminated functional moiety with an equivalent quantity of internal (or pendent) functional moiety, causing a corresponding reduction in the rate of gel formation on fixing members. In this manner the gel formation rate can be varied without changing the viscosity of the release fluid or the concentration of the functionality. It is thought that the likelihood of pendent moieties occurring in linear oligomeric chains is vanishingly small such that the effective likelihood of oligomeric functionality is dominated only by the concentration of the end terminated moiety.

End functional group containing polyorganosiloxane can be represented by the general Formula (i):

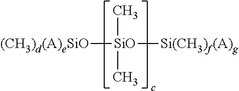

Where A represents the functional moiety, e+d=3, f+g=3, and c is the number of silicone repeat units that make the polymer chain. End terminated silicones of this type are generally prepared by ring opening a low molecular silicone cyclic compound such as D3 or D4 in the presence of an oligomeric silicone that is either trimethyl terminated at both ends, or functionalized at both ends with the desired functional group or functional group precursor group. During the polymerization and subsequent heating and equilibration, the chain ends mix to form a statistical blend of non-functional chains where e+g=0, mono-functional chains where e+g=1, and di-functional chains where e+g>1. The probability of any given chain end having an end functional group is the number of functional groups divided by the number of chain ends.

The functional group (A) comprises carboxy, amine, mercapto, and silane. Amino functionality is a particularly preferred functional group for use in a release agent for fusing thermoplastic toner. The amine group (A) is represented as —R¹—X in which R¹ represents an alkylene group having from 2 to 5 carbon atoms and X represents —NH₂ or —NHR²NH₂ with R² being an alkylene group having 2 to 4 carbons. A preferred amine is where R¹ is 3 and X is —NH₂ such that (A) is aminopropyl.

Amino functionality reacts with fluoroelastomer fuser surfaces to form a protective layer. This protective layer includes a silicone brush that prevents contamination of the fuser surface and promotes wetting by the silicone releasing fluid. Fluoroelastomers include fluorinated and partially fluorinated elastomers and thermoplastic-elastomers. Preferred fluoroelastomers include di-polymers and ter-polymers of vinylidene fluoride, hexafluoropropylene, and tetrafluoroethylene. A preferred fluoroelastomer includes a hydrofluorocarbon terpolymer elastomer having vinylidene fluoride at 1 to 50 mol percent, hexafluoropropylene at 10 to 90 mol percent, and tetrafluoroethylene at 10 to 40 mol percent.

The ratio of the total number of silicone repeat units to the total number of ends dictates the number average molecular weight of the final polymer. The polymer molecular weight affects the viscosity of the release fluid. The releasing fluid viscosity should be low enough to permit uniform delivery to the fixing member yet not be so low as to be volatile or compromise the releasing performance. For good releasing performance the silicone fluid should have a viscosity at 25 C greater than about 100 centistokes and preferably greater than about 200 centistokes. The releasing fluid is delivered to the fixing member surface by an oiler. Oilers include rotating wicks, impregnated webs, and donor roller systems. The desired releasing fluid application rate and uniformity requirement determine the oiler system and the oiler system limits the viscosity of the releasing fluid. For high quality color printing a uniform application of release fluid is required at a rate of from about 2 ul per A4 surface to about 20 ul per A4 surface. A donor roll oiler is a preferred method for uniform application. Donor roller oilers operate best with fluids that are less than about 1000 centistokes, and more preferably less than about 500 centistokes. To achieve the desired viscosity, the molecular weight of the silicone must be controlled. The polymer molecular weight of the silicone release fluid is preferably between about 4000 number average molecular weight to about 40,000 number average molecular weight.

The concentration of functional groups in the releasing fluid should be sufficient that the functional chains are effective. The ratio of the number of functional ends to the total number of repeat units determines the functional group concentration, typically expressed in milli-equivalents per gram (meq/g). The functional group concentration should be greater than about 0.004 meq/g, preferably greater than about 0.008 meq/g. At high concentrations of functional group it becomes difficult to prevent multiple functional groups per chain, and the cost of the fluid increases. The concentration of functional groups should be less than about 0.1 meq/g, more preferably less than about 0.03 and still more preferably less than about 0.016 meq/g.

In the preparation of silicone polymers, low molecular weight oligomers are formed somewhat in excess of what would be expected if the molecular weight distribution was perfectly normal. These oligomers are not easily removed by devolatilization, and therefore are present in most silicone releasing fluids. Fluids prepared to a high number average molecular weight typically show this low molecular weight portion in the distribution. As low molecular weight material have a very high ratio of end groups to repeat unit, end functional silicones typically have a significant portion of functional groups in this oilgomeric portion of the distribution. Oligomers are more mobile and less sterically hindered than larger polymeric chains, and are thus more able to penetrate the silicone brush. It is thought that di-functional oligomers that can penetrate the brush are then able to continue a reaction and thicken the protective silicone layer. As this layer becomes macroscopic in thickness it can start to negatively impact the performance of the fuser roller, for example by causing a loss of fixed image gloss.

The presence of di-functional oligomers in end functional polydimethlysiloxanes is reduced by lowering the likelihood of any chain having more than one functional group. The higher the percentage of functional ends, the greater the likelihood that a functional polymer chain will have more than one functional end group and e+g>1. Conversely, the lower the percentage of functional groups the greater the likelihood a functional chain will have only one group and e+g=1. It is desirable to reduce the number of chains that have e+g>1 so it is desirable to have a large number of non-functional ends relative to functional ends. U.S. Patent Application Publication 20090105100 Ferrar et. al. describes a method for minimizing the presence of di-functional silicone oligomers that contribute to gel formation. Using this method there is a minimum likelihood provided for a desired viscosity and functional group concentration. To reduce the likelihood of di-functional oligomers further requires either lowering the functional group concentration or increasing the number of non-functional ends, for example by lowering the viscosity.

The pendent functional polydimethlysiloxane can be represented by the general Formula (ii):

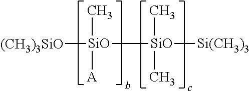

Pendent functional silicones of this type are generally prepared by ring opening a low molecular silicone cyclic compound such as D3 or D4 in the presence of an oligomeric silicone or cyclic that includes repeat units having the desired functional group or functional group precursor group. During the polymerization and subsequent heating and equilibration, the chains mix to form a statistical blend and the pendent functional repeat units “b” are distributed randomly. The probability of any given repeat unit having a pendent functional group is the number of functional groups divided by the total number of repeat units. Higher molecular weight chains in the final distribution of chains necessarily have more repeat units “b” and “c”, so there is a corresponding higher likelihood the larger chain will contain one or more pendent functional groups.

It is desirable to have some level of end functional oligomers to continuously re-build the protective silicone brush as the fixing process continuously wears away at the surface. A fluid comprised only of functional siloxanes represented by Formula (ii) will function as a release fluid, but as the surface degrades and contaminates the surface slowly loses it releasing capability. Fluids prepared exclusively of Formula (ii) have relatively few functional linear oligomers and no end functional oligomers. It is thought that bulky siloxane chains are unable to penetrate the initial brush and are slower at repairing the brush when it is damaged.

In accordance with the present invention substitution of a portion of the end functional amines for pendent functional amines reduces the likelihood of di-functional oligomers as effectively as reducing the functional group concentration, but without changing the fluid viscosity or the actual functional group concentration. This is due to the significantly larger likelihood that pendent functionality will occur within a higher molecular weight chain rather than a lower molecular weight or oligomeric chain.

The combination of end and pendent functional siloxane can be represented by the general Formula (iii):

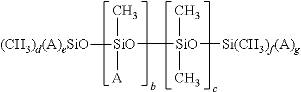

Combination end and pendent functional silicones of this type are prepared by combining the end functional and pendent functional starting materials in the same reaction, or using an appropriate oligomer that includes both end and pendent functionality. During the polymerization and subsequent heating and equilibration, the chains mix to form a statistical blend and the pendent functional units “b” as well as the end functional groups are distributed randomly along the chain and among the chain ends respectively. The final equilibrated material will contain siloxanes of Formula (i), Formula (ii), and Formula (iii).

As described with the siloxanes of Formula (ii) the probability of any given repeat unit having a pendent functional group is the number of pendent functional groups divided by the total number of repeat units. Higher molecular weight chains in the final distribution of chains necessarily have more repeat units “b” and “c”, so there is a corresponding higher likelihood the larger chain will contain one or more pendent functional groups and the probability of pendent functional groups in the oligomers is very low.

In a similar manner the probability of any given chain having an end functional group is the number of end functional groups divided by the number of chain ends. In practice for fluids of the present invention the likelihood that linear oligomers will have end terminated functional groups is so much greater than the likelihood of pendent functional groups; the probability for functional oligomers is essentially identical to the probability of end functional oligomers. Thus the probability of functional linear oligomers can be controlled by the level of substitution of end terminated functionality for pendent functionality. In a preferred embodiment the releasing fluid has a probability of end functional oligomers having e+g>1 of less than about 0.5%, more preferably between about 0.2% and 0.02%. Oligomers are defined here as less than about 10,000 Mn, or less than about 5000 Mn, or less than about 2000 Mn.

The release fluid of the present invention can be further blended with non-functional silicones including polydimethlysiloxane or other functional silicones including amine functional silicones.

In another embodiment of the invention the concentration of di-functional oligomeric compounds in an end-terminated release fluid can be reduce by replacement of a portion of the dimethlysiloxane repeat units, or T2 with trisiloxy, or T3 and tetrasiloxy, or T4 branching units. In this embodiment the branching units increase the likelihood that larger chains will have more endgroups than smaller chains, and this reduces the probability that smaller chains will have functionality greater than 1. A reduced likelihood of multifunctional oligomeric compounds causes a corresponding reduction in the rate of gel formation on fixing members. In this manner the gel formation rate can be varied without changing the viscosity of the release fluid or the concentration of the functionality.

### Comparative Example 1

An end terminated amine functional polydimethlysiloxane release fluid was prepared in a single step equilibrium polymerization having a viscosity of 350 cSt and an amine concentration of 0.012 meq/gram. The likelihood of any given chain having a functional group at both ends is about 0.56%, so the percentage of chains below 10000 Mn having a functional group at both ends is about 0.56%.

### Example 2

An amine functional polydimethlysiloxane release fluid was prepared as described in Example 1 except that 50% of the end-terminated amine moieties were replaced by pendent amine moieties. The likelihood of any chain having a functional group at both ends is about 0.14%; about 28% of the level of comparative example 1. In this case the calculated percentage of chains below 10,000 Mn have more than one pendent group is 0.0033% which is an insignificant contribution.

### Example 3

An amine functional polydimethlysiloxane release fluid was prepared as described in Example 1 except that 75% of the end-terminated amine moieties were replaced by pendent amine moieties. The likelihood of any chain having a functional group at both ends is about 0.035%; about 6.25% of the level of comparative example 1.

### Comparative Example 4

An amine functional polydimethlysiloxane release fluid was prepared as described in Example 1 except that 100% of the end-terminated amine moieties were replaced by pendent amine moieties. The percentage of chains below a molecular weight of about 10000 Mn having more than a single functional group is less than about 0.013%

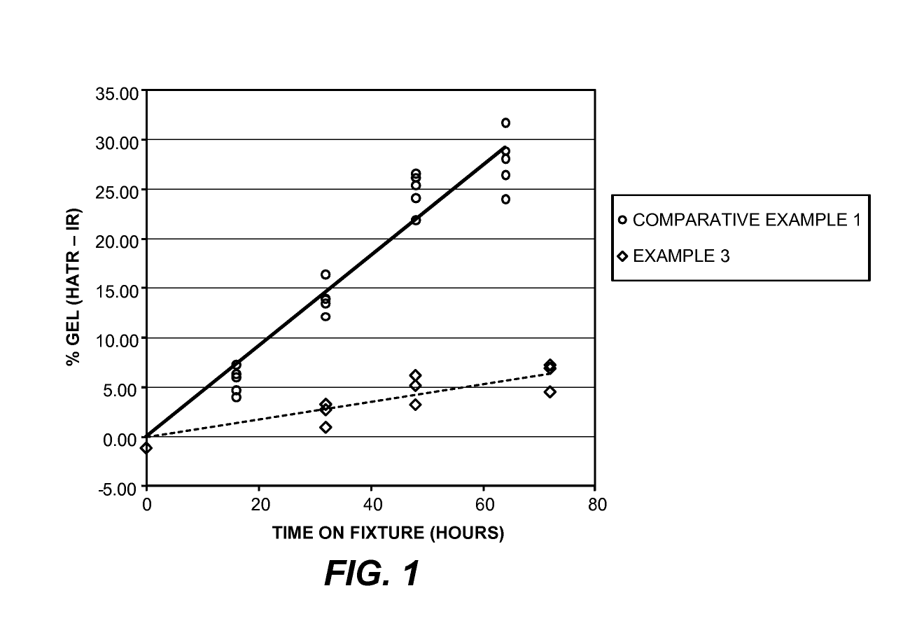

FIG. 1 shows the results of comparing the use of fluids of comparative example 1 and example 3 as tested by running a fixing roller at 175 C in contact with a donor roll oiler and applying the test fluid. The rollers were removed periodically, rinsed with heptanes, and measured for gel formation using a horizontal ATR-IR. The resulting spectra were curve fit to determine the percentage contribution of signal from the surface gel signal. The percentage gel is plotted as a function of hours aged in the fixture. The results in FIG. 1 show that the fluid of example 3 has a significantly reduced gel formation rate compared with the comparative example 1.

The invention has been described in detail with particular reference to certain preferred embodiments thereof, but it will be understood that variations and modifications can be effected within the spirit and scope of the invention.

1. A method for fixing toner images formed on substrates while forming a copolymer gel, comprising:
providing a fuser member having a top surface including a fluoroelastomer surface;
during fusing of images continuously applying a releasing fluid onto the surface of the fusing member wherein the releasing fluid includes an end functional polydimethylsiloxane formed of Formula (i): 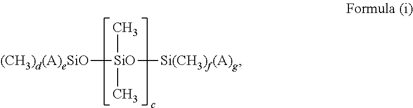
a pendent functional polydimethlysiloxane formed of Formula (ii): 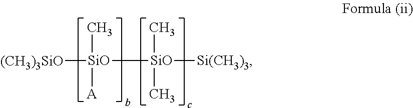
a combination of end and pendent functional siloxane formed of Formula (iii): 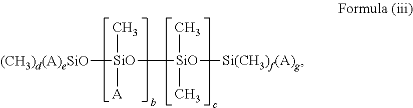
and wherein the release fluid comprises less than 0.5% by weight of the sum of Formula (i) where e+g>1 and Formula (iii) where e+g are >1;
and heating the surface with the release fluid mixture to form a crosslinked copolymeric gel comprising the release mixture components.

2. The method of claim 1 wherein (A) is an amine including aminopropyl.

3. The method of claim 1 wherein the release fluid comprises between about 0.2% and about 0.02% by weight of the sum of Formula (i) where e+g>1 and Formula (iii) where e+g are >1.

4. The method of claim 1 wherein the fluoroelastomer comprises a hydrofluorocarbon terpolymer elastomer having vinylidene fluoride at 1 to 50 mol percent, hexafluoropropylene at 10 to 90 mol percent, and tetrafluoroethylene at 10 to 40 mol percent.

5. The method of claim 1 wherein the release fluid includes a non-functional polydimethlysiloxane.

6. The method of claim 1 wherein the release fluid has a viscosity of between about 200 centistokes and about 500 centistokes

7. The method of claim 1 wherein a portion of repeat units “c” are replaced by branching units.

8. The method of claim 2 wherein the amine concentration of the amine fluid is between about 0.008 meq/g and about 0.016 meq/g.

9. The method of claim 2 wherein the amine functional polydimethlysiloxane has a number average molecular weight of from about 4000 to about 40,000.

10. A releasing fluid comprising: an end functional polydimethylsiloxane formed of Formula (i): 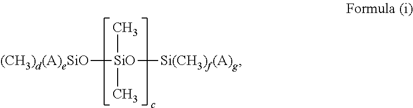
a pendent functional polydimethlysiloxane formed of Formula (ii): 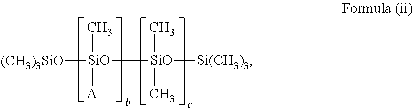
a combination of end and pendent functional siloxane formed of Formula (iii): 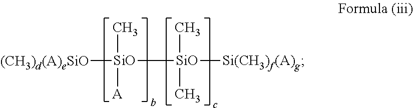
and wherein the release fluid comprises less than 0.5% by weight of the sum of Formula (i) where e+g>1 and Formula (iii) where e+g are >1.

11. The releasing fluid of claim 10 wherein the release fluid comprises between about 0.2% and about 0.02% by weight of the sum of Formula (i) where e+g>1 and of Formula (iii) where e+g are >1, the release fluid has a viscosity of between about 200 centistokes and about 500 centistokes, wherein (A) is an amine, and the amine concentration of the amine fluid is between about 0.008 meq/g and about 0.016 meq/g.

12. The releasing fluid of claim 10 wherein the amine (A) represents —R¹—X in which R¹ represents an alkylene group having from 2 to 5 carbon atoms and X represents —NH₂ or —NHR²NH₂ with R² being an alkylene group having 2 to 4 carbons.

13. The releasing fluid of claim 10 wherein a portion of T2 repeat units “c” are replaced by T3 and T4 branching units.
